(19) United States
(12) Patent Application Publication
(10) Pub. No.: US 2014/0327349 A1
(43) Pub. Date: Nov. 6, 2014

(54) Drawer Handle Mechanism

(71) Applicant: BIO-RAD LABORATORIES, INC., HERCULES, CA (US)

(72) Inventors: Jeffry M. Ceremony, Fairfield, CA (US); Tom McCollum, Berkeley, CA (US)

(73) Assignee: BIO-RAD LABORATORIES, INC., HERCULES, CA (US)

(21) Appl. No.: 14/266,501

(22) Filed: Apr. 30, 2014

Related U.S. Application Data
(60) Provisional application No. 61/818,893, filed on May 2, 2013.

(51) Int. Cl. B01L 7/00

(52) U.S. Cl. CPC B01L 7/52
USPC 312/209; 312/348.6

(57) ABSTRACT

A drawer apparatus having a drawer chassis and a drawer adapted to move relative to the drawer chassis from a closed position to an open position. The drawer has first and second lateral sides. A lid assembly is moveable from an upward position to a downward position relative to the drawer chassis. The lid assembly has first and second roller members. A first lever arm is rotatable about a first pivot on the first lateral side. The first lever arm has a first surface for moveably engaging with the first roller member. A second lever arm is rotatable about a second pivot on the second lateral side. The second lever arm has a second surface for moveably engaging with the second roller. A handle connects the first and second lever arms. The handle is adapted to move the first and second lever arms respectively about the first and second pivots to move the lid assembly from the downward position to the upward position.

### CROSS-REFERENCES TO RELATED APPLICATIONS

This application claims the benefit of U.S. Provisional Application No. 61/818,893, filed on May 2, 2013, which is incorporated by reference herein.

### BACKGROUND OF THE INVENTION

Thermal cyclers are devices used to amplify samples for performing a polymerase chain reaction (PCR). Typically, such devices include a thermal block for holding a tray of PCR samples. Many devices include a lid for sealing the samples. Often these lids are heated to prevent condensation caused by thermal cycling the samples. Other non-PCR devices also include lids that cover a sample tray.

User access to the samples is not always convenient. Often the lids of thermal cyclers and other system are hinged at a top most region of the device. In such units the sample tray can be held in a recessed area under the lid that is awkward to reach. Some systems can provide the tray to the user in a rollout drawer, which simplifies access. However, mechanisms required to do so can be unnecessarily complex and add greatly to cost, especially in the case of automated systems. Accordingly, there remains a need to provide improved access to sample trays.

### BRIEF SUMMARY OF THE INVENTION

Embodiments of the invention relate to a handle and drawer mechanism that is usable with thermal cyclers and PCR systems with integrated thermal cyclers. The mechanism is provided to raise a lid, which is in contact with sample. Raising the handle raises the lid, and then the drawer can be pulled out to access the sample. In some embodiments, lowering the handle raises the lid. In either case, handle motion is reversed as drawer is pushed inwards in order to lower the lid onto the sample. Handle lever arms can operate on opposite sides of a pivot to accommodate the change in actuation. The handle remains in an upper position when the drawer is pulled open. The upper position of the handle readies the sample to receive the internal lid (which is raised) when the drawer is returned to its closed position. The lid may be heated or non-heated. The lid can include a transparent window that allows a user and/or monitoring devices to observe the sample during thermal cycling. The window is coated with a transparent material that enables the window to be heated.

Some embodiments relate to drawer apparatus having a drawer chassis and a drawer adapted to move relative to the drawer chassis from a closed position to an open position. The drawer can have first and second lateral sides. A lid assembly is moveable from an upward position to a downward position relative to the drawer chassis. The lid assembly can have first and second roller members. A first lever arm is rotatable about a first pivot on the first lateral side. The first lever arm has a first surface for moveably engaging with the first roller member. A second lever arm is rotatable about a second pivot on the second lateral side. The second lever arm has a second surface for moveably engaging with the second roller. A handle connects the first and second lever arms. The handle can be adapted to move the first and second lever arms respectively about the first and second pivots to move the lid assembly from the downward position to the upward position.

Some embodiments relate to a method, in which the drawer is moved from the closed position to the open position, and the lid assembly is moved from the downward position to the upward position relative to the drawer chassis while moving the drawer. Moving the drawer includes moving the handle to actuate the first and second lever arms respectively about the first and second pivots, thereby moving the lid assembly from the downward position to the upward position.

In some embodiments, the drawer is not moveable from the closed position to the open position unless the lid assembly is in the upward position.

In some embodiments, the first and second surfaces comprise elongated surfaces.

In some embodiments, the elongated surfaces are non-horizontal when the lid assembly is in the downward position.

In some embodiments, the drawer comprises transfer surfaces adjacent to the elongate surfaces. The transfer surfaces are moved to replace the elongate surfaces to contact the first and second rollers when the drawer is in the open position.

In some embodiments, the handle is lockable to the drawer while the lid assembly is in the upward position.

In some embodiments, the lid assembly is biased to apply a downward force to the first and second lever arms.

In some embodiments, the lid assembly is biased by a spring held by a portion of the chassis.

In some embodiments, the lid assembly comprises a heater.

In some embodiments, the lid assembly comprises a lid frame holding an optical component.

In some embodiments, the optical component comprises a lens having a transparent conductive material for conducting heat.

In some embodiments, the transparent conductive material comprises indium tin oxide (ITO), graphene, carbon nanotubes, inherently conductive polymers (ICP's), aluminum doped zinc oxide (AZO), gallium doped zinc oxide (GZO), or indium doped zinc oxide (IZO).

In some embodiments, the drawer chassis is part of a thermal cycler or a system for performing PCR.

### BRIEF DESCRIPTION OF THE DRAWINGS

FIG. 1A is a perspective view a drawer apparatus, according to some embodiments.

FIGS. 1B-1D are cross-sectional views of the drawer apparatus of FIG. 1A.

FIG. 2 is a cross-sectional view of a lid with an optical component, according to some embodiments.

### DETAILED DESCRIPTION OF THE INVENTION

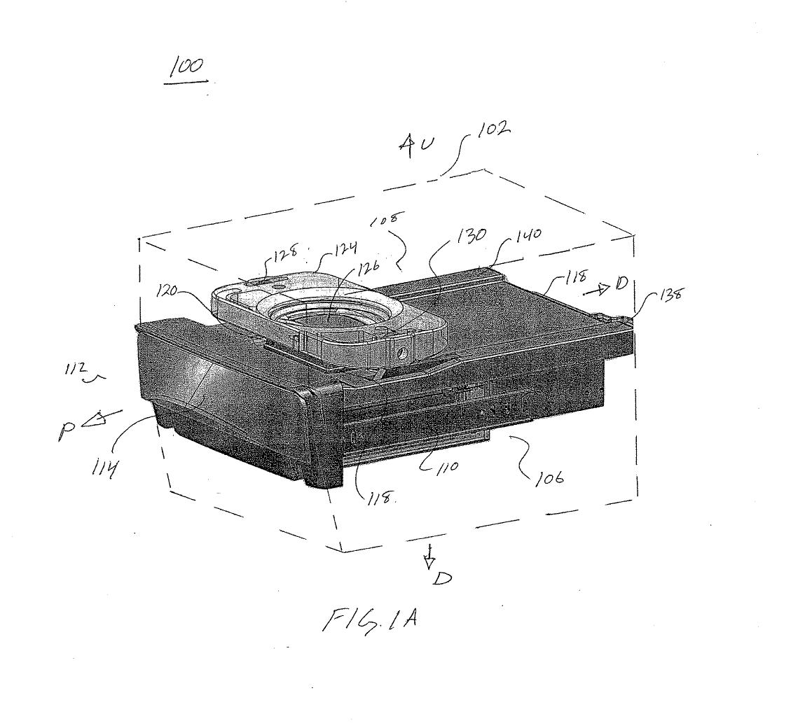

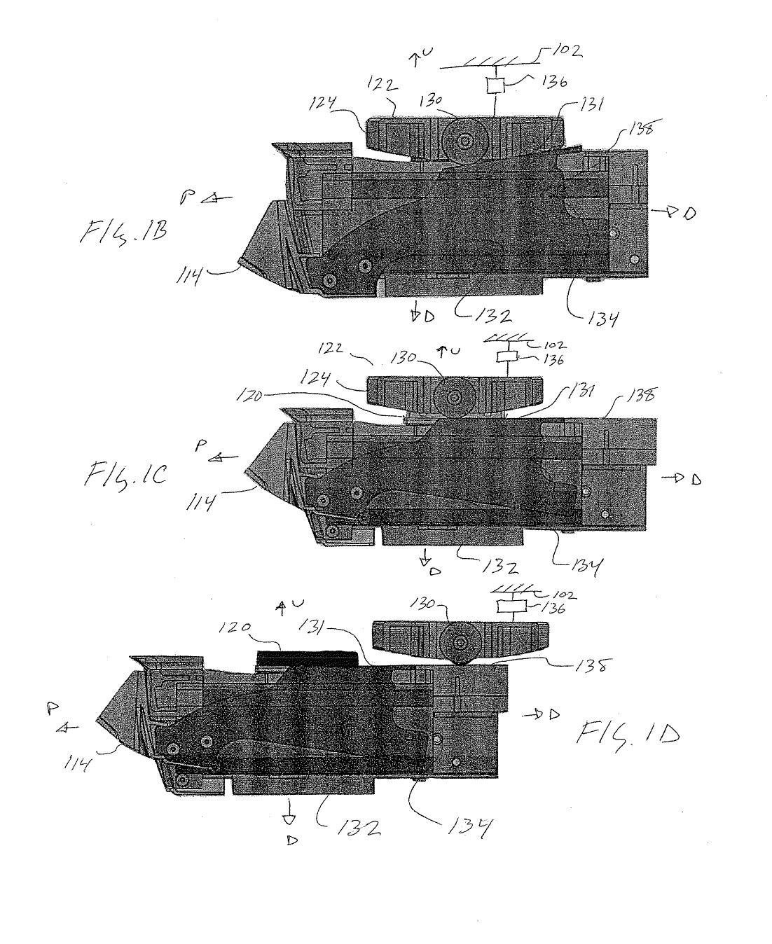

FIG. 1A shows a perspective view of a drawer apparatus 100. The drawer apparatus 100 includes a drawer 104 that is moveably connected to a drawer chassis 102, which typically includes at least one support structure for the drawer apparatus 100 to connect to. In many embodiments, the drawer chassis 102 is part of a thermal cycler or a system for performing PCR integrated with a thermal cycler, such as the model C-1000 TOUCH by BIO-RAD.

The drawer apparatus 100 includes a drawer 104 that has lateral portions 106/108 on each lateral side of the drawer 104. The lateral portions 106/108 include rails 110 for slidably mounting the drawer 104 to the drawer chassis 102. Accordingly, the drawer 104 is configured to move relative to the drawer chassis 102 from a closed (distal D) position to an open (proximal P) position, as shown by the arrows.

The drawer 104 also includes a front portion 112 that includes a moveable handle 114 that extends to each lateral portion. A top portion 116 separates and connects the lateral portions 106/108. The top portion 116 includes a holding region 118 for holding a removable sample tray 120. The holding region 118 can include a thermal block for heating the sample tray 120. The drawer 104 also includes rear and bottom portions that are not visible in this view. Generally, one skilled in the art would understand that portions of the drawer can be constructed from sheets and/or frame members of metal or polymer that are assembled or otherwise integrated in whole or part.

The drawer apparatus 100 includes a lid assembly 122 that is moveably attached to the drawer chassis 102. The lid assembly 122 can be non-heated, or heated via a heater (e.g. resistive heater) integrated into the lid assembly to prevent moisture build-up. The lid assembly 122 is configured to move upward U and downward D relative to the drawer chassis 104 and generally transverse to the movement of the drawer 104, as indicated by the directional arrows. The lid assembly 122 can be configured only move upward and downward relative to the chassis, and is directionally fixed otherwise. The lid assembly 122 can be spring-biased towards the downward position. The lid assembly 122 includes a lid frame 124 that spans the drawer 104. In some embodiments, the lid frame 124 holds an optical component 126 (e.g., window, lens) that is optionally coated with a conductive material. In the downward position of the lid assembly 122, the optical component 126 is directly proximate to the sample tray 120, when the drawer 104 is closed. Additional features of the lid assembly 122 are discussed below.

The lid frame 124 interfaces with the drawer 104 by way of the roller members 128/130, which are shown here as freely rotatable wheels. This is illustrated in detail within FIG. 1B, which shows a partial cross-section of the drawer apparatus 100. The roller member 130 is shown in contact with a lever arm surface 131, which may be a flat elongated surface, of a lever arm 132. The roller member 130 is biased against the lever arm surface 131 by way of a spring (pneumatic or mechanical) 136 that is interconnected between the frame 124 and the drawer chassis 102. The spring 136 is schematically depicted, since its implementation is not critical and readily achieved by one skilled in the art.

The lever arm 132 is moveable about a pivot 134 and also rigidly connects to the handle 114. The handle 114 also connects, on the side of the lateral portion 108 not shown, to another lever arm that is configured to be largely symmetric to the shown lever arm 132. The lever arm 132 is generally adapted to have two resting positions, with the lower position depicted in FIG. 1B, and an upper position as depicted in FIGS. 1C (and 1A). When the lever arm 132 is placed into the upper position the lid assembly 122 is also raised to an upward position, by way of the lever arm surface 131 transferring force applied to the handle to the roller member 130. The handle 114 can be locked into the upper position shown in FIG. 1C, and also into the lower position shown in FIG. 1B, by way of a latch (not shown).

The position achieved in FIG. 1C allows the drawer 104 to be moved from a closed position shown in FIGS. 1A-1C to an open position as shown in FIG. 1D. In some embodiments, the drawer 104 may not be moved to the open position unless the lever arm 132 is in an upper position, as shown in FIG. 1C, since the spring-biased roller member 130 interferes with such movement. This is because the lever arm surface 131, while in the lower position, is placed at an angle with respect to a transfer surface 138 of the lateral portion 108. Thus, the spring-biased roller member 130 acts as a physical stop against the angled lever arm surface 131, since the roller member 130 is horizontally fixed.

However, in the upper position shown in FIGS. 1C and 1D, the lever arm surface 131 is made horizontal, i.e., coplanar with the transfer surface 138. Thus, in the upper position the roller member 132 does not act as a physical stop against the lever arm surface 131. This allows the drawer 104 to be opened from the closed position shown in FIG. 1C to the open position shown in FIG. 1D. In the open position of the drawer 104, the transfer surfaces 138/140 are moved proximally and thus placed into contact with respective roller members 128/130.

In the upper position of the lever arm 132, the lid assembly 122 is raised upward by way of the movement of the lever arm surface 131 against the roller member 130. In this manner, the lid assembly 122 is raised above the sample tray 120. And, as described above, the drawer 104 is moveable to the open position shown in FIG. 1D. This makes the sample tray 120 accessible and removable by a user of the drawer assembly 100.

In use, a user may approach the closed drawer 104 and pull on the lowered handle 114 in the proximal direction in an attempt to open the drawer 104. However, the drawer 104 will not open because roller members 128/130 are spring-biased against the angularly displaced lever arm surfaces, thus preventing proximal movement of the drawer 104. Thus, the drawer 104 cannot be opened by casual interaction.

Accordingly, in use, the user may approach the closed drawer 104 and lift the handle 114. This causes the lever arms connected to the handle 114 to lift up the roller members 128/130 of the lid assembly 122 that covers the sample tray 120. The handle 114 is then maintained in an upper position, for example by depressing or releasing a latch mechanism that locks the handle 114 to the front portion 112 of the drawer 104. In this manner, the lid assembly 122 is moved away from the drawer 104 into an upward position. The user may then open the drawer 104 by pulling the handle away from the drawer chassis 102 in a proximal direction. While doing so, lever arm surfaces are transferred away from the roller members 128/130, and transfer surfaces 138/140 are rolled under the roller members 128/130. The sample tray 120 is now exposed and accessible to the user. The sample tray 120 may then be replaced or removed entirely. The user can then push the drawer 104 closed such that the drawer 104 is placed into the distal position with respect to the drawer chassis 102. In this manner the lever arm surfaces are brought back into contact with the roller members 128/130. The user then operates the handle 114 to move the handle 114 from the upper position to the lower position, thus angularly displacing the lever arm surfaces such that the roller members 128/130 prevent proximal movement of the drawer 104.

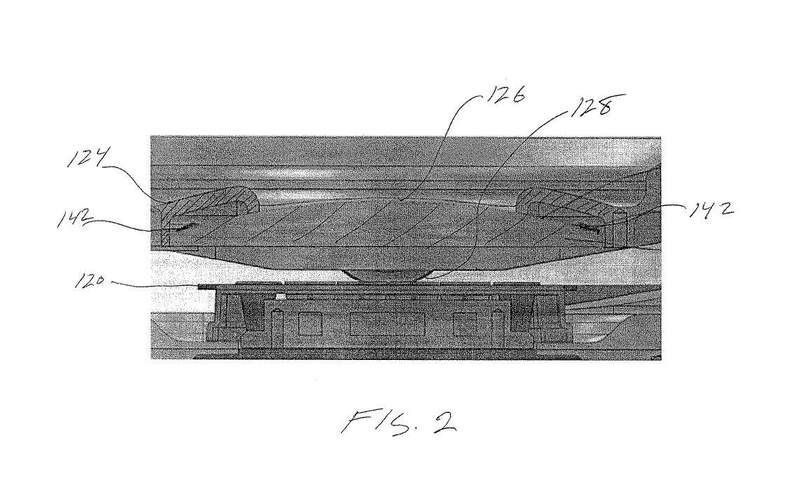

FIG. 2 shows a cross-sectional view of the drawer apparatus 100 bisecting the lid assembly 122, while the lid assembly 122 is in the upward position. In the closed position of the drawer 104, the lid frame 124 holds the optical component 126 against the sample tray 120. The optical component 126 is constructed from a transparent material (e.g., glass, ceramic, polymer) to allow monitoring of the sample tray 120 by a user and/or monitoring devices. The optical component 126 may be curved to magnify this view. The optical component 126 can be coated with a conductive thin film material (e.g. indium tin oxide (ITO), graphene, carbon nanotubes, inherently conductive polymers (ICPs), aluminum doped zinc oxide (AZO), gallium doped zinc oxide (GZO), or indium doped zinc oxide (IZO)), which is electrically connected to bus bars 142. The conductive thin film can cover both upper and lower surfaces of the optical component 126, or only one of those sides.

In use, the sample tray 120 can contain a plurality of samples for performing an operation, such as thermal cycling. Accordingly, the sample tray can contain liquids that are heated over several cycles. Heating causes evaporation of the liquids into vapor, which can condense on the optical component 126, thus blocking view and potentially disrupting the test if droplets fall back into the sample tray 120. To prevent this, the optical component 126 resistively heats by supplying energy to the conductive thin film by way of the bus bars 142. The heated optical component 126 does not allow vapors to condense, and thus a user and/or monitoring devices can observe the sample tray without disruption during thermal cycling.

Although the above description contains much specificity, these should not be construed as limitations on the scope of the invention, but merely as illustrations of some embodiments. Many possible variations and modifications to the invention will be apparent to one skilled in the art upon consideration of this disclosure. For example, while the drawer apparatus moves the lid assembly upward according to an upward movement of the handle, in some embodiments, the drawer apparatus can be configured to actuate the lid assembly upward with a downward motion. In addition, while the drawer apparatus depicts two lever arms, in some embodiments only one lever arm is used. In addition, while the drawer apparatus depicts the lid assembly with an optical component, in some embodiments, the lid assembly has no optical component, and in some embodiments the optical component is used as a lid in a conventional manner, i.e., without the drawer apparatus.

What is claimed is:

1. A drawer apparatus comprising:
a drawer chassis;
a drawer adapted to move relative to the drawer chassis from a closed position to an open position, the drawer having first and second lateral sides;
a lid assembly moveable from an upward position to a downward position relative to the drawer chassis, the lid assembly having first and second roller members;
a first lever arm rotatable about a first pivot on the first lateral side, the first lever arm having a first surface for moveably engaging with the first roller member;
a second lever arm rotatable about a second pivot on the second lateral side, the second lever arm having a second surface for moveably engaging with the second roller; and
a handle connected to the first and second lever arms, the handle being adapted to move the first and second lever arms respectively about the first and second pivots to move the lid assembly from the downward position to the upward position.

2. The drawer apparatus of claim 1, wherein the drawer is not moveable from the closed position to the open position unless the lid assembly is in the upward position.

3. The drawer apparatus of claim 1, wherein the first and second surfaces comprise elongated surfaces.

4. The drawer apparatus of claim 3, wherein the elongated surfaces are non-horizontal when the lid assembly is in the downward position.

5. The drawer apparatus of claim 3, wherein the drawer comprises transfer surfaces adjacent to the elongate surfaces, and wherein the elongated surfaces transfer surfaces are moveable to replace the elongate surfaces to contact the first and second rollers when the drawer is in the open position.

6. The drawer apparatus of claim 1, wherein the handle is lockable to the drawer while the lid assembly is in the upward position.

7. The drawer apparatus of claim 1, wherein the lid assembly is biased to apply a downward force to the first and second lever arms.

8. The drawer apparatus of claim 6, wherein the lid assembly is biased by a spring held by a portion of the chassis.

9. The drawer apparatus of claim 1, wherein the lid assembly comprises a heater.

10. The drawer apparatus of claim 1, wherein the lid assembly comprises a lid frame holding an optical component.

11. The drawer apparatus of claim 10, wherein the optical component comprises a lens having a transparent conductive material for conducting heat.

12. The drawer apparatus of claim 11, wherein the transparent conductive material comprises indium tin oxide (ITO), graphene, carbon nanotubes, inherently conductive polymers (ICPs), aluminum doped zinc oxide (AZO), gallium doped zinc oxide (GZO), or indium doped zinc oxide (IZO).

13. The drawer apparatus of claim 1, wherein the drawer chassis is part of a thermal cycler or a system for performing PCR.

14. A method comprising:
moving a drawer adapted to move relative to a drawer chassis from a closed position to an open position, the drawer having first and second lateral sides;
moving a lid assembly from a downward position to an upward position relative to the drawer chassis while moving the drawer, the lid assembly having first and second roller members;
wherein a first lever arm is rotatable about a first pivot on the first lateral side, the first lever arm having a first surface for moveably engaging with the first roller member;
wherein a second lever arm is rotatable about a second pivot on the second lateral side, the second lever arm having a second surface for moveably engaging with the second roller; and
wherein a handle is connected to the first and second lever arms, wherein moving the drawer comprises moving the handle to actuate the first and second lever arms respectively about the first and second pivots, thereby moving the lid assembly from the downward position to the upward position.

15. The method of claim 14, wherein the drawer is not moveable from the closed position to the open position unless the lid assembly is in the upward position.

16. The method of claim 14, wherein the first and second surfaces comprise elongated surfaces.

17. The method of claim 16, wherein the elongated surfaces are non-horizontal when the lid assembly is in the downward position.

18. The method of claim 16, wherein the drawer comprises transfer surfaces adjacent to the elongate surfaces, and wherein the elongated surfaces transfer surfaces are moved to replace the elongate surfaces to contact the first and second rollers when the drawer is in the open position.

19. The method of claim 14, wherein the handle is locked to the drawer while the lid assembly is in the upward position.

20. The method of claim 14, wherein the lid assembly applies a downward force to the first and second lever arms.

21. The method of claim 20, wherein the lid assembly is biased by a spring held by a portion of the chassis.

22. The method of claim 14, wherein the lid assembly comprises a lid frame holding an optical component adapted to conduct heat.

23. The method of claim 22, wherein the optical component comprises a lens having a transparent conductive material.

24. The method of claim 23, wherein the transparent conductive material comprises indium tin oxide.

25. The method of claim 14, wherein the drawer chassis is part of a thermal cycler or a system for performing PCR.
